(19) United States
(12) Patent Application Publication
(10) Pub. No.: US 2007/0037940 A1
(43) Pub. Date: Feb. 15, 2007

(54) Romp with fluorinated groups

(76) Inventors: Dario Lazzari, Bologna (IT); Piero Piccinelli, Marconi (IT); Alessandro Zedda, Basel (CH); Francesca Peri, Bologna (IT); Martin Brunner, Wallbach (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/571,649

(22) PCT Filed: Sep. 15, 2004
(86) PCT No.: PCT/EP04/52190

§ 371 Date: Mar. 14, 2006

(30) Foreign Application Priority Data
Sep. 25, 2003 (EP) 03103564.5

(51) Int. Cl. C08F 4/80

(52) U.S. Cl. 526/171

(57) ABSTRACT

The instant invention relates to new metathesis oligomers which are substituted with fluorinated groups. Also disclosed is a polymerisable composition comprising a catalytically effective amount of a penta- or hexavalent ruthenium or osmium carbene catalyst, the process for preparing the metathesis oligomers by applying the reaction conditions of Ring Opening Metathesis Polymerisation (ROMP) to the polymerisable composition. These new methathesis oligomers are useful for increasing the oil and water repellency of organic materials.

The instant invention relates to new metathesis oligomers which are substituted with fluorinated groups. Also disclosed is a polymerisable composition comprising a catalytically effective amount of a penta- or hexavalent ruthenium or osmium carbene catalyst, the process for preparing the metathesis oligomers by applying the reaction conditions of Ring Opening Metathesis Polymerisation (ROMP) to the polymerisable composition. These new methathesis oligomers are useful for various technical applications such as for example for increasing the oil and water repellency of organic materials like for example synthetic polymers.

The use of various fluorochemical compositions on fibers and fibrous substrates, such as for example textiles, carpets, paper, leather and non-woven webs to impart oil and water repellency is known for example in U.S. Pat. No. 6,127,485. This reference discloses hydrophobic and oleophobic fibers, films and molded articles comprising synthetic organic polymer wherein dispersed within the fiber, fabric or molded article and present at the surface of the fiber, fabric or molded article are fluorochemical compounds. The fluorochemical compounds are fluorochemical esters or amides derived from a dimer or trimer acid.

WO-A-01/62821 discloses ROMP polymers wherein an aromatic group that has UV-light absorbing properties is attached with a bridge group to the polymer. These compounds are useful as stabilizers against degradation by light, heat or oxidation, particularly as stabilizers of synthetic polymers.

EP-A-1 241 196 disclosed ROMP oligomers wherein one or more alkoxy ether groups are attached to the oligomeric moiety. These compounds are useful for preventing the fog formation from humidity under polymer films.

It has now been found that new metathesis oligomers which are substituted with fluorinated groups are useful for various technical applications such as for example for increasing the oil and water repellency of organic materials like for example synthetic polymers.

The present invention therefore provides a compound of the formula I 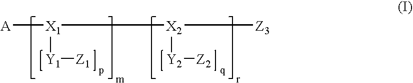
wherein
m and n independently of one another is zero, one or a numeral greater than one, with the proviso that the sum of m and n is at least two;
p and q independently of one another is zero, one or a numeral greater than one, with the proviso that, when p and q are zero, Z₃ is a fluorine containing group;
r is 1, 2, 3 or 4,
A and Z₃ represent chain terminal groups from the chain transfer agent (A)ᵣ—Z₃;
X₁ and X₂ independently of one another represent unsaturated or hydrogenated repeating units from cycloolefins polymerized by metathesis;
Y₁ and Y₂ independently of one another represent identical or different bivalent groups;
Z₁ and Z₂ independently of one another represent a fluorine containing residue,
Z₃ represents a mono-, di-, tri- or tetra-valent residue or a mono-, di-, tri- or tetra-valent residue optionally substituted with a fluorine containing residue.

The indices m and n have no real upper limits. In a preferred embodiment, the sum of m and n has a range from 2 to 50, preferably 5 to 20, whereas 5 to 10 are particularly preferred. In another preferred embodiment, one of m and n is a numeral from 2 to 50 and the other one is zero.

Preferably, p and q independently of one another is 0 or 1, with the proviso that, when p and q are 0, Z₃ is a fluorine containing group.

The compound of the formula I comprises any polymeric compound wherein the lowest total number of repeating units X₁ and X₂ is two. The compound of the formula I comprises any polymeric compounds of low molecular weight, such as oligomers or co-oligomers, or homo-polymers and copolymers of higher molecular weight, for example block, multi-block or gradient copolymers as well as copolymers characterized by a random, hyper-branched, star-shaped or dendritic arrangement of the polymer units as well as graft copolymers.

The compounds of the formula I are obtainable by metathesis polymerisation, as opposed to other methods of polymerisation, such as ionic or free radical polymerisation. Metathesis polymerisation is characterised by the ring-opening polymerisation of cycloalkenes initiated by olefin metathesis catalysts, cf. Concise Encyclopaedia of Polymer Science and Engineering, J. I. Kroschwitz (editor), J. Wiley & Sons USA, 1990 Edition, ISBN 0-471-51253-2, pg. 611. Representative cycloalkenes polymerisable by this method include dicyclopentadiene, norbornadiene, norbornene, cyclooctene and cyclooctadiene.

The polymerisation by metathesis is performed in the presence of chain transfer agents (CTA) of the formula (A)ᵣ—Z₃ wherein A and Z₃ represent chain terminal groups. Chain transfer agents are used to regulate and limit the molecular weight in a polymer reaction, cf. F. W. Billmeyer, Polymer Science, ISBN 0-471-03196-8, pg. 63.

Suitable chain transfer agents are open chain alkenes, e.g. propylene, n-butene, n-hexene or n-octene, which are present in the compound of the formula I as identical or different terminal alkyl groups A and Z₃. In a particularly preferred embodiment A and Z₃ are different and p and q are zero.

The term cycloolefin polymerised or polymerisable by metathesis defining X₁ and X₂ includes monocyclic cycloolefins other than cyclohexene and polycyclic, polycyclic condensed (fused) or bridged or polycyclic condensed (fused) and bridged cycloolefins. The individual rings in these cycloolefins consist of 3 to 16, especially 3 to 12, and preferably 3 to 8 ring members and may contain heteroatoms selected from the group consisting of O, S, N and Si and additional substituents selected from the group consisting of C₁-C₄alkyl, e. g. methyl or ethyl, C₁-C₄alkoxy, e. g. methoxy or ethoxy, halogen, e.g. chloro or bromo, cyano and trifluoromethyl.

A preferred group includes cycloolefins polymerised by metathesis selected from the group consisting of cyclopropene, cyclobutene, cyclopentene, cycloheptene, cyclooctene, cyclopentadiene, dicyclopentadiene, cyclohexadiene, cycloheptadiene, cyclooctadiene, norbornadiene, norbornene and norbornene derivatives.

Another preferred group of cycloolefins includes bi-, tri-, tetra- and pentacyclic bridged cycloolefins obtainable by a Diels-Alder type addition reaction of dienes with so-called dienophiles. The individual rings in these bridged cycloolefinic adducts may be condensed with monocyclic or bicyclic carbocyclic aromatic groups, such as benzene or naphthalene, or with monocyclic or bicyclic heterocyclic aromatic groups, such as thiophene, furan, pyridine or quinoline.

This preferred group of cycloolefins includes carbocyclic bi-, tri-, tetra- and pentacyclic bridged cycloolefins obtainable by a Diels-Alder type addition reaction, especially cycloolefins by Diels-Alder reaction of cyclopentadiene with suitable dienophiles.

A preferred group of cycloolefins of this type includes monomers based on norbornene and norbornadiene selected from the group consisting of norbornene-2,5-methoxycarbonylnorbornene-2,5-methyl5-methoxycarbonyl-norbornene-2,5-cyanonorbornene-2,5-methyl-5-cyanonorbornene, 5,5-dicyano-norbornene-2,1,4,5,8-dimethano-1,4,4a,5,6,7,8,8a-octahydronaphthaline, 6-methyl-1,4,5,8-dimethano-1,4,4a,5,6,7,8,8a-octahydronaphthaline, 6-methyl-6-methoxycarbonyl-1,4,5,8-dimethano-1,4,4a,5,6,7,8,8a-octahydronaphthaline, 6-methoxycarbonyl-1,4,5,8-dimethano-1,4,4a,5,6,7,8,8a-octahydronaphthaline, 6-cyano-1,4,5,8-dimethano-1,4,4a,5,6,7,8,8a-octahydronaphthaline, 6-ethyl-1,4,5,8-dimethano-1,4,4a,5,6,7,8,8a-octahydronaphthaline, 6-ethylidene-1,4,5,8-dimethano-1,4,4a,5,6,7,8,8a-octahydronaphthaline, 6,7-dimethyl-1,4,5,8-dimethano-1,4,4a,5,6,7,8,8a-octahydronaphthaline, 1,4-dimethano-1,4,4a,9a-tetrahydrofluorene, dicyclopentadiene, tricyclopentadiene, tetracylopentadiene, tetracyclododecene and methyl tetracyclododecene.

Of interest are compounds of the formula I, wherein in the chain transfer agent (A)ᵣ—Z₃,
wherein, when r is 1,
A—Z₃ is C₃-C₂₅alkyl-1-ene, trifluoroethyl allyl ether, heptafluorobutyl allyl ether, nonafluorohexyl allyl ether, CF₃(CF₂)₆CH₂CH₂OCH₂CH═CH₂,
CF₃(CF₂)₇CH₂CH₂OCH₂CH═CH₂, allyl trifluoroacetate, 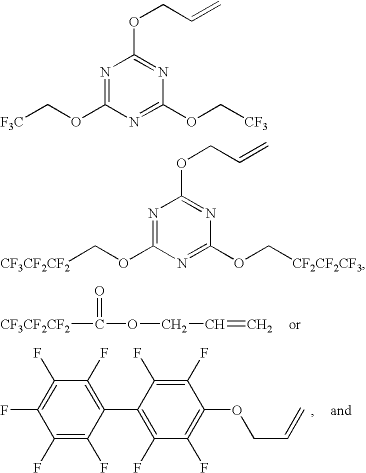
   wherein, when r is 2,
(A)₂—Z₃ is H₂C═CH—CH₂—O [symbol] CF₂ [symbol] ₉CH₂—CH₂—O—CH₂—CH═CH₂ or
H₂C═CH—CH₂—O—CH₂ [symbol] CF₂ [symbol] ₁₀CH₂—O—CH₂—CH═CH₂.

The bivalent groups Y₁ and Y₂ are present in the event that one of p and q is one or a numeral greater than one. Preferred meanings of Y₁ and Y₂ are —C(═O)—, —O—C(═O)—, C₁-C₈alkylene or a direct bond. Preferably, Y₁ and Y₂ independently of one another is a direct bond or methylene.

Of special interest are compounds of the formula I wherein Z₁ and Z₂ independently of one another represent a fluorine containing residue selected from the group consisting of C₃-C₂₅-fluoroalkyl, C₃-C₂₅fluoroalkoxy or

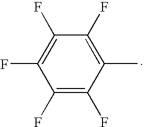

Of interest are also compounds of the formula I, wherein
one of m and n represents a numeral from 2 to 20; and the other one represents zero,
p and q indepently of one another is 0 or 1, with the proviso that, when p and q are 0, Z₃ is a fluorine containing group;
r is 1 or 2,
A and Z₃ represent chain terminal groups from the chain transfer agent (A)ᵣ—Z₃;
X₁ and X₂ independently of one another represent unsaturated or hydrogenated repeating units from cycloolefins polymerized by metathesis selected from the group consisting of cyclopentadiene, dicyclopentadiene, norbornadiene, norbornene and norbornene derivatives,
Y₁ and Y₂ independently of one another is a direct bond or methylene,
Z₁ and Z₂ Independently of one another represent a fluorine containing residue selected from the group consisting of C₃-C₂₅fluoroalkyl, C₃-C₂₅fluoroalkoxy or 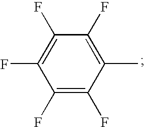
   and
when r is 1,
A—Z₃ is C₃-C₂₅alkyl-1-ene, trifluoroethyl allyl ether, heptafluorobutyl allyl ether, nonafluorohexyl allyl ether, CF₃(CF₂)₆CH₂CH₂OCH₂CH═CH₂,
CF₃(CF₂)₇CH₂CH₂OCH₂CH═CH₂, allyl trifluoroacetate, 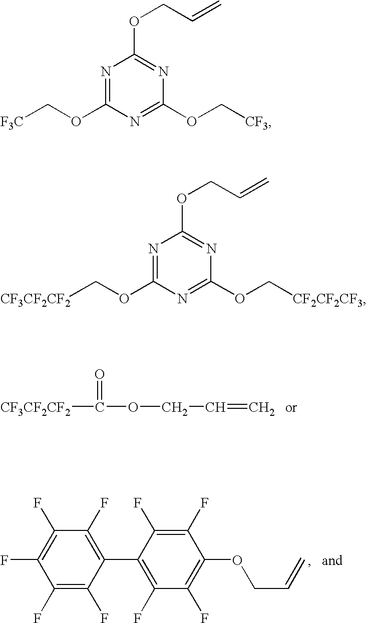
when r is 2,
(A)₂—Z₃ is H₂C═CH—CH₂—O [symbol] CF₂ [symbol] ₉CH₂—CH₂—O—CH₂—CH═CH₂ or
H₂C═CH—CH₂—O—CH₂ [symbol] CF₂ [symbol] ₁₀CH₂—O—CH₂—CH═CH₂.

The present invention also relates to a polymerisable composition comprising
a) a catalytically effective amount of a penta- or hexavalent ruthenium or osmium carbene catalyst capable of performing ring opening metathesis polymerization of cycloolefins; and
b) the chain transfer agent (A)ᵣ—Z₃ as defined above and monomers capable of forming a compound of the formula I.

A suitable penta- or hexavalent ruthenium or osmium carbene catalyst present in the composition mentioned above is described on pages 12-44 of Olefin Metathesis and Metathesis Polymerization; K. J. Ivin, J. C. Mol, Academic Press, ISBN 0-12-377045-9.

Of interest is a polymerisable composition comprising as component (a) a catalytically effecttive amount of a penta- or hexavalent ruthenium or osmium carbene catalyst of the formulae IIa and IIb 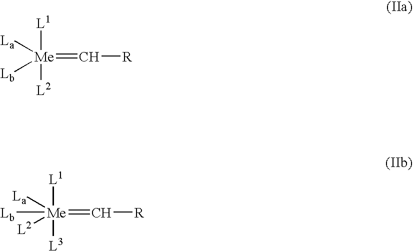
wherein
Me represents ruthenium or osmium;
Lₐ and L_{b} independently of one another represent anionic ligands;
L¹, L² and L³ independently of one another represent monodentate, neutral e⁻ donor ligands; and
R represents aryl, arylthio or C₃-C₅alkenyl.

The polymerisable compositions comprising as component a) the penta- or hexavalent ruthenium or osmium carbene catalysts (IIa) and (IIb) defined above and as component b) the chain transfer agent capable of forming the compound (I) defined above are a preferred embodiment of the invention.

The anionic ligands Lₐ and L_{b} are, for example, hydride ions (H⁻) or are derived from inorganic or organic acids, examples being halides, e.g. F⁻, Cl⁻, Br⁻ or I⁻, fluoro complexes of the type BF₄⁻, PF₈⁻, SbF₈⁻ or AsF₆⁻, anions of oxygen acids, alcoholates or acetylides or anions of cyclopentadiene.

The anions of oxygen acids can be, for example, the sulphate, phosphate, perchlorate, perbromate, periodate, antimonate, arsenate, nitrate, or carbonate ions, the anion of a C₁-C₈-carboxylic acid, such as formate, acetate, propionate, butyrate, benzoate, phenylacetate, mono-, di- or trichloro- or -fluoroacetate, sulphonates, for example methyl-, ethyl-, propyl-, or n-butylsulphonate, trifluoromethylsulphonate (triflate), phenylsulphonate or benzylsulphonate or phenylsulphonate and benzylsulphonate substituted by C₁-C₄alkyl, C₁-C₄alkoxy or halogen, especially fluoro, chloro or bromo, for example tosylate, mesylate, brosylate, p-methoxy- or p-ethoxyphenylsulphonate, pentafluorophenylsulphonate or 2,4,6-triisopropylsulphonate.

Particularly preferred anionic ligands Lₐ and L_{b} are H⁻, F⁻, Cl⁻, Br⁻, BF₄⁻, PF₆⁻, SbF₆⁻, AsF₆⁻, CF₃SO₃⁻, C₆H₅—SO₃⁻, 4-methyl-C₆H₄—SO₃⁻, 3,5-dimethyl-C₆H3—SO₃⁻, 2,4,6-trimethyl-C₆H₂—SO₃⁻ and 4—CF₃—C₆H₄—SO₃⁻ and also cyclopentadienyl (Cp⁻). Cl⁻ is especially preferred.

In the compounds of the formulae IIa and IIb up to three neutral ligands L¹, L² and L³ are tertiary-substituted phosphine having 3- about 40, preferably 3-30, and, with particular preference, 3-18 carbon atoms. The tertiary-substituted phosphine is preferably a compound of the formula III 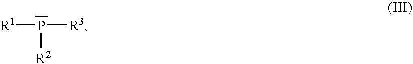
in which R¹, R² and R³ independently of one another are C₁-C₂₀alkyl, C₃-C₁₂cycloalkyl, C₂-C₁₁heterocycloalkyl, C₆-C₁₂aryl, C₁-C₁₂heteroaryl or C₆-C₁₄aralkyl, which may be substituted by one or more substituents selected from the group consisting of C₁-C₆alkyl, C₁-C₆alkoxy, C₁-C₆haloalkyl, C₅-C₁₂aryl, —NO₂, SO₃⁻, ammonium and halogen; the radicals R¹ and R² together are tetra- or pentamethylene, which may be substituted by one or more substituents selected from the group consisting of C₁-C₆alkyl, C₁-C₆haloalkyl, NO₂ and C₁-C₆alkoxy, or R¹ and R² represent tetra- or pentamethylene, which may be fused to 1 or 2 1,2-phenylene radicals, and wherein R³ is as defined above.

Particular preferred are phosphines wherein R¹, R² and R³ are methyl, ethyl, n- or i-propyl, n-, i-, s- or t-butyl, 1-, 2- or 3-pentyl, 1-, 2-, 3- or 4-hexyl, cyclopentyl, cyclohexyl, phenyl, naphthyl or benzyl, e.g. (i-C₃H₇)₃P, (C₅H₉)₃P and (C₆H₁₁)₃P.

In the compounds of the formulae IIa and IIb one or two of the neutral ligands L¹, L² and L³ are monodentate, neutral e⁻ donor ligands having electron donor properties, or two ligands together are bidentate, neutral e⁻ donor ligands.

Such ligands are derived from heteroarenes, e.g. heteroarenes selected from the group consisting of furan, thiophene, pyrrole, pyridine, bis-pyridine, picolylimine, γ-pyran, γ-thiopyran, phenanthroline, pyrimidine, bis-pyrimidine, pyrazine, indole, coumarone, thionaphthene, carbazole, dibenzofuran, dibenzothiophene, pyrazole, imidazole, benzimidazole, oxazole, thiazole, bis-thiazole, isoxazole, isothiazole, quinoline, bis-quinoline, isoquinoline, bis-isoquinoline, acridine, chromene, phenazine, phenoxazine, phenothiazine, triazine, thianthrene, purine, bis-imidazole and bis-oxazole.

These ligands may further be substituted by suitable substituents selected from the group consisting of C₁-C₆alkyl, C₁-C₆alkoxy, carboxy, C₁-C₆alkoxycarbonyl, C₁-C₆haloalkyl, nitro, sulpho, ammonium and halogen.

Aryl and arylthio R is, for example phenyl or phenylthio or phenyl and phenylthio substituted by one or more substituents selected from the group consisting of C₁-C₆alkyl, C₁-C₆alkoxy, carboxy, C₁-C₆alkoxycarbonyl, C₁-C₆haloalkyl, nitro, sulpho, ammonium and halogen. C₃-C₅alkenyl is, for example, vinyl, 1-, 2- or 3-propenyl, or the different butenyl, pentenyl or hexenyl isomers, 1,3-hexadienyl or 2,4,6-heptatrienyl or is ethylidene, 1- or 2-propylidene or 1-, 2- or 3-propylidene directly attached to the carbene group. These substituents may be substituted with additional substituents selected from the group consisting of halogen, C₁-C₅alkoxy and phenyl, which in turn may be substituted with C₁-C₅alkyl, halogen, or C₁-C₅alkoxy.

The monomers and chain transfer agents can be present in an amount of from 0.01 to 99% by weight, preferably from 0.1 to 95% by weight, with particular preference from 1 to 90% by weight and, with especial preference, from 5 to 80% by weight, based on the monomers present in the composition.

The composition may comprise inert solvents. One particular advantage is that in the case of liquid monomers metathesis polymerisation can be carried out without the use of a solvent. A further advantage is that the polymerisation can even be carried out in water, polar and protic solvents or water/solvent mixtures.

Examples of suitable inert solvents are protic polar and aprotic solvents, which can be used alone or in mixtures of at least two solvents. Examples are ethers (dibutyl ether, tetrahydro -furan, dioxane, ethylene glycol monomethyl or dimethyl ether, ethylene glycol monoethyl or diethyl ether, diethylene glycol diethyl ether, triethylene glycol dimethyl ether), halogenated hydrocarbons, etc.

In the context of the present invention, catalytic amounts denote preferably an amount from 0.001 to 1.0 mol-%, with particular preference from 0.01 to 0.5 mol-% and, with very particular preference, from 0.01 to 0.1 mol-%, based on the amount of monomer.

Of special interest is a polymerisable composition comprising as component (a) a catalytically effective amount of a penta- or hexavalent ruthenium carbene catalyst of

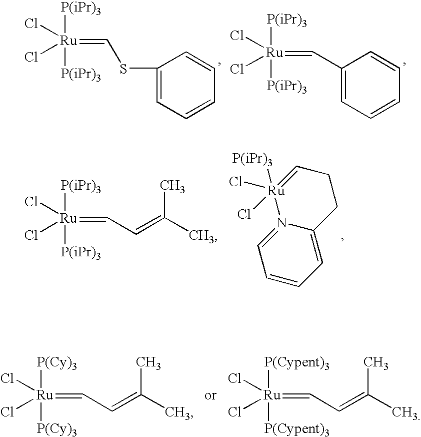

Another embodiment of the invention relates to a composition comprising
a) an organic material which is susceptible to oxidative, thermal or light-induced degradation, and
b) at least one compound of the formula I as defined above.

Illustrative examples of such materials are:
1. Polymers of monoolefins and diolefins, for example polypropylene, polyisobutylene, polybut-1-ene, poly-1-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature.
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.
5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.
6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrenelethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.
7. Graft copolymers of vinyl aromatic monomers such as styrene or (x-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloridelvinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes which contain ethylene oxide as a comonomer; polyacetals modified with thermoplastic polyurethanes, acrylates or MBS.
14. Polyphenylene oxides and sulfides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetra glycol; as well as polyamides or copolyamides modified with EPDM or ABS; and polyamides condensed during processing (RIM polyamide systems).
17. Polyureas, polyimides, polyamide-imides, polyetherimids, polyesterimids, polyhydantoins and polybenzimidazoles.
18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.
19. Polycarbonates and polyester carbonates.
20. Polysulfones, polyether sulfones and polyether ketones.
21. Crosslinked polymers derived from aldehydes on the one hand and phenols, ureas and melamines on the other hand, such as phenol/formaldehyde resins, urea/formaldehyde resins and melamine/formaldehyde resins.
22. Drying and non-drying alkyd resins.
23. Unsaturated polyester resins derived from copolyesters of saturated and unsaturated dicarboxylic acids with polyhydric alcohols and vinyl compounds as crosslinking agents, and also halogen-containing modifications thereof of low flammability.
24. Crosslinkable acrylic resins derived from substituted acrylates, for example epoxy acrylates, urethane acrylates or polyester acrylates.
25. Alkyd resins, polyester resins and acrylate resins crosslinked with melamine resins, urea resins, isocyanates, isocyanurates, polyisocyanates or epoxy resins.
26. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.
27. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.
28. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
29. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.
30. Aqueous emulsions of natural or synthetic rubber, e.g. natural latex or latices of carboxylated styrene/butadiene copolymers.

Preferred organic materials are natural, semi-synthetic or, preferably, synthetic polymers.

Particularly referred organic materials are synthetic polymers, most preferably thermoplastic polymers. Especially preferred organic materials are polyacetals, polyolefins such as polypropylene or polyethylene, polyether/polyurethanes, polyesters such as polybutylene terephthalate, polycarbonates or vulcanisates.

To be singled out for special mention is the efficacy of the novel compounds of the formula I as oil and water repellency agent for an organic material.

The compounds of the formula I will preferably be added to the organic material to be stabilized in concentrations of 0.001 to 10%, preferably 0.001 to 2%, typically 0.01 to 2%, based on the weight of said material.

In addition to comprising the compounds of the formula 1, the inventive compositions may comprise further additives, typically the following:
1. Antioxidants
1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl4-n-butylphenol, 2,6-di-tert-bu-tyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-meth-oxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.
1.2. Alkylthiomethylphenols, for example 2,4-dioctylthiomethyl-6-tert-butylphenol, 2,4-dioctyl -thiomethyl-6-methylphenol, 2,4-dioctylthiomethyl-6-ethylphenol, 2,6-di-dodecylthiomethyl4-nonylphenol.
1.3. Hydroquinones and alkylated hydroquinones, for example 2,6-di-tert-butyl-4-methoxy -phenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, δ-tocopherol and mixtures thereof (vitamin E).
1.5. Hydroxylated thiodiphenyl ethers, for example 2,2′-thiobis(6-tert-butyl4-methylphenol), 2,2′-thiobis(4-octylphenol), 4,4′-thiobis(6-tert-butyl-3-methylphenol), 4,4′-thiobis(6-tert-butyl -2-methylphenol), 4,4′-thiobis(3,6-di-sec-amylphenol), 4,4′-bis(2,6-dimethyl hydroxyphenyl) -disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra(5-tert-butyl-4-hydroxy-2-methylphenyl)pentane.
1.7. O-, N- and S-benzyl compounds, for example 3,5,3′, 5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris -(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-(3-{3-tert-butyl-4-hydroxy-5-methylphenyl)propionyloxy}-1,1-dimethylethyl]-2,4,8,10-tetraoxaspiro[5.5]-undecane.
1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).
1.18. Ascorbic acid (vitamin C)
1.19. Aminic antioxidants, for example N,N′-di-isopropyl-p-phenylenediamine, N,N′-di-sec -butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p -phenylenediamine, N-cyclohexyl-N′-phenyl-p-phenylenediamine, 4-(p -toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino -methylphenol, 2,4′-diaminodiphenylmethane, 4,4′-diaminodiphenylmethane, N,N,N′,N′-tetra -methyl-4,4′-diaminodiphenylmethane, 1,2-bis[(2-methylphenyl)amino]ethane, 1,2-bis(phenyl -amino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro3,3-dimethyl-4H-1,4-benzothiazine, phenothiazine, a mixture of mono- and dialkylated tert -butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetra -methylpiperid-4-yl-hexamethylenediamine, bis(2,2,6,6-tetramethylpiperid4-yl)sebacate, 2,2,6,6-tetramethylpiperidin-4-one, 2,2,6,6-tetramethylpiperidin4-ol.
2. UV absorbers and light stabilizers
2.1. 2-(2′-Hydroxyphenyl)benzotriazoles, for example 2-(2′-hydroxy-5′-methylphenyl)benzo-triazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di -tert-butyl-2′-hydroxyphenyl)-5-chlorobenzotriazole, 2-(3′-tert-butyl-2′-hydroxy-5′-methylphenyl-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′, 5′-di-tert-amyl-2′-hydroxyphenyl)benzotriazole, 2-(3′, 5′-bis(α,α-dimethylbenzyl)-2′-hydroxyphenyl)benzotriazole, 2-(3′-tert-butyl-2′-hydroxy-5′-(2-octyloxycarbonylethyl)phenyl) -5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert -butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂ [symbol] , where R=3′-tert-butyl-4′-hydroxy-5′-2H -benzotriazol-2-ylphenyl, 2-[2′-hydroxy-3′-(α,α,dimethylbenzyl)-5′-(1,1,3,3-tetramethylbutyl)phenyl]benzotriazole; 2-[2′-hydroxy-3′-1,1,3,3-tetramethylbutyl)-5′-(α,α-dimethylbenzyl)phenyl]benzotriazole.
2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butylhydroxybenzoate, hexadecyl 3,5-di-tert-butylhydroxybenzoate, octadecyl 3,5-di-tert-butyl-4-hydroxybenzoate, 2-methyl-4,6-di-tert-butylphenyl 3,5-di-tert-butylhydroxybenzoate.
2.4. Acrylates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(βcarbomethoxy-β-cyanovinyl)-2-methylindoline.
2.5. Nickel compounds, for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert -butylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.
2.6. Sterically hindered amines, for example bis(2,2,6,6-tetramethylpiperidyl)sebacate, bis(2,2,6,6-tetramethyl-4-piperidyl)succinate, bis(1,2,2,6,6-pentamethylpiperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert -butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro4,6-bis(4-n-butylamino-2,2,6,6-tetramethylpiperidyl)-1,3,5-triazine and 1,2-bis(3-aminopropylamino)ethane, the condensate of 2-chloro4,6-di-(4-n-butylamino-1,2,2,6,6-pentamethylpiperidyl-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine.
2.7. Oxamides, for example 4,4′-dioctyloxyoxanilide, 2,2′-diethoxyoxanilide, 2,2′-dioctyloxy5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyly)-3,5-triazine, 2(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis-(2,4-dimethylphenyl)-1,3,5-triazine.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di -cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl) -pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo -[triethyltris(3,3′,5,5′-tetra-tert-butyl-1,1′-biphenyl-2,2′-diyl)phosphite], 2-ethylhexyl(3,3′,5,5′-te-tra-tert-butyl-1,1′-biphenyl-2,2′-diyl)phosphite, 5-butyl-5-ethyl-2-(2,4,6-tri-tert-butylphenoxy)-1,3,2-dioxaphosphirane.
5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine.
6. Nitrones, for example N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate or distearyl thiodipropionate.
8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(β-dodecylmercapto)propionate.
9. Polyamide stabilizers, for example copper salts in combination with iodides and/or phosphorus compounds and salts of divalent manganese.
10. Basic co-stabilizers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′, 4′-dimethylbenzylidene)sorbitol, 1,3:2,4-di(paramethyldibenzylidene)sorbitol, and 1,3:2,4-di(benzylidene)sorbitol.
12. Fillers and reinforcing agents, for example calcium carbonate, silicates, glass fibres, glass bulbs, asbestos, talc, kaolin, mica, barium sulfate, metal oxides and hydroxides, carbon black, graphite, wood flour and flours or fibers of other natural products, synthetic fibers.
13. Other additives, for example plastcisers, lubricants, emulsifiers, pigments, rheology additives, catalysts, flow-control agents, optical brighteners, flameproofing agents, antistatic agents and blowing agents.
14. Benzofuranones and indolinones, for example those disclosed in U.S. Pat. Nos. 4,325,863; U.S. 4,338,244; U.S. 5,175,312; U.S. 5,216,052; U.S. 5,252,643; DE-A-4316611; DE-A-4316622; DE-A-4316876; EP-A-0589839 or EP-A-0591102 or 3-[4-(2-acetoxyethoxy) -phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-3,5-dimethyl-4pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one.

The further additives are typically used in concentrations of 0.01 to 10%, based on the total weight of the material to be treated.

The novel compounds of the formula I can be used in particular together with phenolic antioxidants, light stabilizers and/or processing stabilizers.

Incorporation of component (b) and, if desired, further additives into the synthetic polymers is carried out by known methods, for example before or during moulding or else by applying the dissolved or dispersed compounds to the synthetic polymer, if appropriate with subsequent slow evaporation of the solvent.

The present invention also relates to a composition in the form of a masterbatch or concentrate comprising component (a) in an amount of from 5 to 90% and component (b) in an amount of from 5 to 80% by weight.

Components (b) and, if desired, further additives, can also be added before or during polymerisation or before crosslinking.

Component (b), with or without further additives, can be incorporated in pure form or encapsulated in waxes, oils or polymers into the synthetic polymer.

Component (b), with or without further additives, can also be sprayed onto the synthetic polymer. It is able to dilute other additives (for example the conventional additives indicated above) or their melts so that they too can be sprayed together with these additives onto the polymer. Addition by spraying on during the deactivation of the polymerization catalysts is particularly advantageous, it being possible to carry out spraying using, for example, the steam used for deactivation.

In the case of spherically polymerized polyolefins it may, for example, be advantageous to apply component (b), with or without other additives, by spraying.

The synthetic polymers prepared in this way can be employed in a wide variety of forms, for example as foams, films, fibres, tapes, moulding compositions, as profiles or as binders for coating materials, especially powder coatings, adhesives, putties or especially as thick-layer polyolefin mouldings which are in long-term contact with extractive media, such as, for example, pipes for liquids or gases, films, fibres, geomembranes, tapes, profiles or tanks.

The preferred thick-layer polyolefin mouldings have a layer thickness of from 1 to 50 mm, in particular from 1 to 30 mm, for example from 2 to 10 mm.

The compositions according to the invention can be advantageously used for the preparation of various shaped articles. Examples are:
I-1) Floating devices, marine applications, pontoons, buoys, plastic lumber for decks, piers, boats, kayaks, oars, and beach reinforcements.
I-2) Automotive applications, in particular bumpers, dashboards, battery, rear and front linings, moldings parts under the hood, hat shelf, trunk linings, interior linings, air bag covers, electronic moldings for fittings (lights), panes for dashboards, headlamp glass, instrument panel, exterior linings, upholstery, automotive lights, head lights, parking lights, rear lights, stop lights, interior and exterior trims; door panels; gas tank; glazing front side; rear windows; seat backing, exterior panels, wire insulation, profile extrusion for sealing, cladding, pillar covers, chassis parts, exhaust systems, fuel filter/filler, fuel pumps, fuel tank, body side mouldings, convertible tops, exterior mirrors, exterior trim, fasteners/fixings, front end module, glass, hinges, lock systems, luggage/roof racks, pressed/stamped parts, seals, side impact protection, sound deadener/insulator and sunroof.
I-3) Road traffic devices, in particular sign postings, posts for road marking, car accessories, warning triangles, medical cases, helmets, tires.
I-4) Devices for plane, railway, motor car (car, motorbike) including furnishings.
I-5) Devices for space applications, in particular rockets and satellites, e.g. reentry shields.
I-6) Devices for architecture and design, mining applications, acoustic quietized systems, street refuges, and shelters.
II-1) Appliances, cases and coverings in general and electric/electronic devices (personal computer, telephone, portable phone, printer, television-sets, audio and video devices), flower pots, satellite TV bowl, and panel devices.
II-2) Jacketing for other materials such as steel or textiles.
II-3) Devices for the electronic industry, in particular insulation for plugs, especially computer plugs, cases for electric and electronic parts, printed boards, and materials for electronic data storage such as chips, check cards or credit cards.
II-4) Electric appliances, in particular washing machines, tumblers, ovens (microwave oven), dish-washers, mixers, and irons.
II-5) Covers for lights (e.g. street-lights, lamp-shades).
II-6) Applications in wire and cable (semi-conductor, insulation and cable-jacketing).
II-7) Foils for condensers, refrigerators, heating devices, air conditioners, encapsulating of electronics, semi-conductors, coffee machines, and vacuum cleaners.
III-1) Technical articles such as cogwheel (gear), slide fittings, spacers, screws, bolts, handles, and knobs.
III-2) Rotor blades, ventilators and windmill vanes, solar devices, swimming pools, swimming pool covers, pool liners, pond liners, closets, wardrobes, dividing walls, slat walls, folding walls, roofs, shutters (e.g. roller shutters), fittings, connections between pipes, sleeves, and conveyor belts.
III-3) Sanitary articles, in particular shower cubicles, lavatory seats, covers, and sinks.
III-4) Hygienic articles, in particular diapers (babies, adult incontinence), feminine hygiene articles, shower curtains, brushes, mats, tubs, mobile toilets, tooth brushes, and bed pans.
III-5) Pipes (cross-linked or not) for water, waste water and chemicals, pipes for wire and cable protection, pipes for gas, oil and sewage, guttering, down pipes, and drainage systems.
III-6) Profiles of any geometry (window panes) and siding.
III-7) Glass substitutes, in particular extruded plates, glazing for buildings (monolithic, twin or multiwall), aircraft, schools, extruded sheets, window film for architectural glazing, train, transportation, sanitary articles, and greenhouse.
III-8) Plates (walls, cutting board), extrusion-coating (photographic paper, tetrapack and pipe coating), silos, wood substitute, plastic lumber, wood composites, walls, surfaces, furniture, decorative foil, floor coverings (interior and exterior applications), flooring, duck boards, and tiles.
III-9) Intake and outlet manifolds.
III-10) Cement-, concrete-, composite-applications and covers, siding and cladding, hand rails, banisters, kitchen work tops, roofing, roofing sheets, tiles, and tarpaulins.
IV-1) Plates (walls and cutting board), trays, artificial grass, astroturf, artificial covering for stadium rings (athletics), artificial floor for stadium rings (athletics), and tapes.
IV-2) Woven fabrics continuous and staple, fibers (carpets/hygienic articles/geotextiles/monofilaments; filters; wipes/curtains (shades) /medical applications), bulk fibers (applications such as gown/protection clothes), nets, ropes, cables, strings, cords, threads, safety seat-belts, clothes, underwear, gloves; boots; rubber boots, intimate apparel, garments, swimwear, sportswear, umbrellas (parasol, sunshade), parachutes, paraglides, sails, “balloon-silk”, camping articles, tents, airbeds, sun beds, bulk bags, and bags.
IV-3) Membranes, insulation, covers and seals for roofs, tunnels, dumps, ponds, dumps, walls roofing membranes, geomembranes, swimming pools, curtains (shades)/sun-shields, awnings, canopies, wallpaper, food packing and wrapping (flexible and solid), medical packaging (flexible & solid), airbags/safety belts, arm- and head rests, carpets, centre console, dashboard, cockpits, door, overhead console module, door trim, headliners, interior lighting, interior mirrors, parcel shelf, rear luggage cover, seats, steering column, steering wheel, textiles, and trunk trim.
V) Films (packaging, dump, laminating, agriculture and horticulture, greenhouse, mulch, tunnel, silage), bale wrap, swimming pools, waste bags, wallpaper, stretch film, raffia, desalination film, batteries, and connectors.
VI-1) Food packing and wrapping (flexible and solid), bottles.
VI-2) Storage systems such as boxes (crates), luggage, chest, household boxes, pallets, shelves, tracks, screw boxes, packs, and cans.
VI-3) Cartridges, syringes, medical applications, containers for any transportation, waste baskets and waste bins, waste bags, bins, dust bins, bin liners, wheely bins, container in general, tanks for water/used water/chemistry/gas/oil/gasoline/diesel; tank liners, boxes, crates, battery cases, troughs, medical devices such as piston, ophthalmic applications, diagnostic devices, and packing for pharmaceuticals blister.
VII-1) Extrusion coating (photo paper, tetrapack, pipe coating), household articles of any kind (e.g. appliances, thermos bottle/clothes hanger), fastening systems such as plugs, wire and cable clamps, zippers, closures, locks, and snap-closures.
VII-2) Support devices, articles for the leisure time such as sports and fitness devices, gymnastics mats, ski-boots, inline-skates, skis, big foot, athletic surfaces (e.g. tennis grounds); screw tops, tops and stoppers for bottles, and cans.
VII-3) Furniture In general, foamed articles (cushions, impact absorbers), foams, sponges, dish clothes, mats, garden chairs, stadium seats, tables, couches, toys, building kits (boards/figures/balls), playhouses, slides, and play vehicles.
VII-4) Materials for optical and magnetic data storage.
VII-5) Kitchen ware (eating, drinking, cooking, storing).
VII-6) Boxes for CD's, cassettes and video tapes; DVD electronic articles, office supplies of any kind (ball-point pens, stamps and ink-pads, mouse, shelves, tracks), bottles of any volume and content (drinks, detergents, cosmetics including perfumes), and adhesive tapes.
VII-7) Footwear (shoes/shoe-soles), insoles, spats, adhesives, structural adhesives, food boxes (fruit, vegetables, meat, fish), synthetic paper, labels for bottles, couches, artificial joints (human), printing plates (flexographic), printed circuit boards, and display technologies.
VII-8) Devices of filled polymers (talc, chalk, china clay (kaolin), wollastonite, pigments, carbon black, TiO₂, mica, nanocomposites, dolomite, silicates, glass, asbestos).

Thus, a further embodiment of the present invention relates to a shaped article, in particular a film, pipe, profile, bottle, tank or container, fiber containing a composition as described above.

A further embodiment of the present invention relates to a molded article containing a composition as described above. The molding is in particular effected by injection, blow, compression, roto-molding or slush-molding or extrusion.

The present invention also relates to a process for increasing the oil and water repellency of organic materials which comprises incorporating therein or applying thereto at least one compound of the formula I [component b)].

The preferred compound of the formula I or component (b) respectively, and optionally further additives, in the process for increasing the oil and water repellency of organic materials are the same as those described for the composition.

A preferred embodiment of the present invention is also the use of a compound of the formula I as oil and water repellency agent for an organic material.

The following examples illustrate the invention further. Parts or percentages relate to weight.

### EXAMPLE 1

### Preparation of the Compounds of the Formula 101 and 102

a) Preparation of the compound of the formula A1.

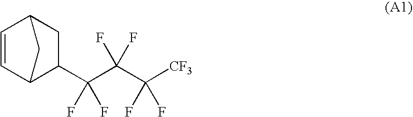

In a sealed vessel are introduced 7.00 g (0.05 mol) of dicyclopentadiene and 31.30 g (0.13 mol) of 1H, 1H, 2H-perfluorohexene. The mixture is kept at 165-170° C. for 70 hours then, by distillation at room pressure a colorless oil (b.p. 165-167° C.) is obtained. ¹H NMR: (300 MHz, CDCl₃), mixture of endo and exo isomers: δ=6.17 (m, 1H, CH═), 5.94 (m, 1H, CH═), 3.16 (m, 1H, CH), 2.92 (m, 1H, CH), 2.76 (m, 1H, CHCF₂), 1.96 (m, 1 H, CHH), 1.46 (m, 1H, CHH), 1.30-1.20 (m, 2H, 2CHH).
b) Preparation of the compound of the formula 101.

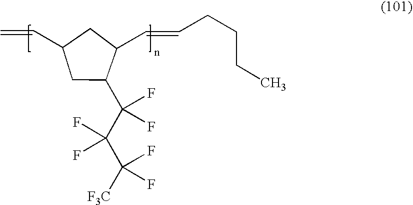

To a solution of 0.5 ml (4.00 mmol) of 1-hexene in 10 ml of toluene is added 0.40 g (0.56 mmol) of the catalyst bis(tricyclopentylphosphine)dichloro(3-methyl-2-butenylidene)ruthenium (APT Cat ASMC 716). A solution of 15.00 g (0.05 mol) of the compound of the formula A1 [prepared according to Example 1a] in 20 ml of toluene is dropped into the reaction mixture. The reaction is kept at ca. 50° C. for 6 hours and then filtered. After evaporation of the solvent a brown resin is obtained.
c) Preparation of the compound of the formula 102.

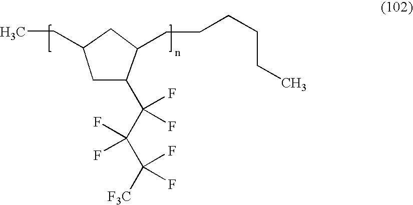

To a solution of 15.30 g of the compound of the formula 101 [prepared according to Example 1b] in 200 ml of toluene, 0.15 g (1% on polymer weight) of 10%w/w platinum on carbon was added. The mixture is poured into an autoclave and hydrogenated for 24 h at 100° C. and 40 bar (pH₂). After filtration and evaporation of the solvent a yellow resin is obtained. Mₙ: 3672; M_{w}: 5878; PDI: 1.60.

### EXAMPLE 2

### Preparation of the Compounds of the Formula 103 and 104

a) Preparation of the compound of the formula A2.

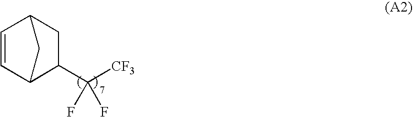

In a sealed vessel is introduced 5.00 g (0.04 mol) of dicyclopentadiene and 40.50 g (0.09 mol) of heptadecafluoro-1-decene. The mixture is kept a t 165-170° C. for 60 hours, then, by distillation under vacuum, a colorless oil (b.p. 85-90° C.) is obtained. ¹H NMR: (300 MHz, CDCl₃), mixture of endo and exo isomers: δ=6.21 (m, 1H, CH═), 5.98 (m, 1H, CH═), 3.19 (m, 1H, CH), 2.95 (m, 1H, CH), 2.80 (m, 1H, CHCF₂), 2.00 (m, 1H, CHH), 1.54-1.25 (m, 3H, CHH and CH₂).
b) Preparation of the compound of the formula 103.

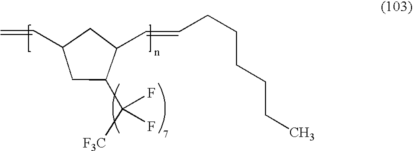

To a solution of 0.4 ml (2.40 mmol) of 1-octene in 10 ml of toluene is added 0.40 g (0.56 mmol) of the catalyst bis(tricydopentylphosphine)dichloro(3-methyl-2-butenylidene)ruthenium (APT Cat ASMC 716). A solution of 15.00 g (0.03 mol) of the compound of the formula A2 [prepared according to Example 2a] in 20 ml of toluene is dropped into the reaction mixture. The reaction mixture is kept at ca. 50° C. for 6 hours and then filtered. After evaporation of the solvent a brown resin is obtained.
c) Preparation of the compound of the formula 104.

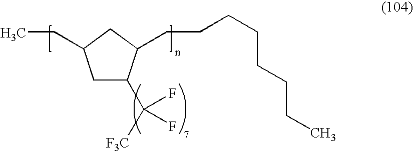

In analogy to Example 1c the compound of the formula 104 is obtained as a yellow resin.

### EXAMPLE 3

### Preparation of the Compounds of the Formula 105 and 106

a) Preparation of the compound of the formula A3.

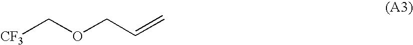

In a sealed vessel is introduced 30.00 g (0.30 mol) of trifluoroethanol, 24.00 g (0.60 mol) of NaOH, 36.30 g (0.30 mol) of allyl bromide and 100 ml of dibuthyl ether. The mixture is heated at 80° C. for 16 hours. After filtration of the salts the solution is distilled at room pressure to give a yellow oil (b.p. 97-100° C.). ¹H NMR: (300 MHz, CDCl₃): δ=5.90 (m, 1H, CH═), 5.27 (m, 2H, CH₂═), 4.00 (m, 2H, OCH₂), 3.90 (m, 2H, OCH₂).
b) Preparation of the compound of the formula A4.

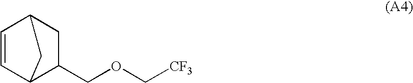

In a sealed vessel is introduced 7.10 g (0.05 mol) of dicyclopentadiene and 20.00 g (0.14 mol) of the compound of the formula A3 [prepared according to Example 3a]. The mixture is kept at 165-170° C. for 72 hours. The reaction mixture is distilled by at room pressure to give a colorless oil (b.p. 160-170° C.). ¹H NMR: (300 MHz, CDCl₃), mixture of endo and exo isomers: 67 =6.08 (m, 1H, CH═), 5.88 (m, 1H, CH═), 3.74 (m, 2H, OCH₂CF₃), 3.31 (m, 1H, OCHH), 3.18 (t, 1H, OCHH), 2.87 (m, 1H, CH), 2.75 (m, 1H, CH), 2.37 (m, 1H, CH), 1.75 (m, 1H, CHH), 1.52-1.12 (m, 2H, CH₂), 0.45 (m, 1H, CHH).
c) Preparation of the compound of the formula 105.

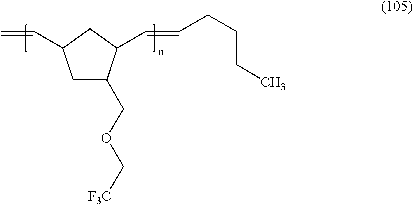

To a solution of 0.7 ml (5.40 mmol) of 1-hexene in 10 ml of toluene is added 0.40 g (0.56 mmol) of the catalyst bis(tricydopentylphosphine)dichloro(3-methyl-2-butenylidene)ruthenium (APT Cat ASMC 716). A solution of 13.40 g (0.06 mol) of the compound of the formula A4 [prepared according to Example 3b] in 20 ml of toluene is dropped into the reaction mixture. The reaction is kept at appr. 50° C. for 6 hours and then filtered. After evaporation of the solvent a brown resin is obtained. Mₙ: 2541; M_{w}: 4058; PDI: 1.60.
d) Preparation of the compound of the formula 106.

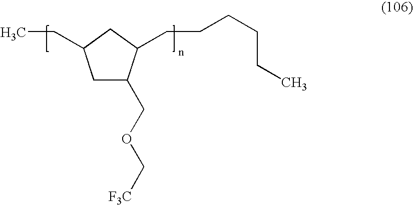

In analogy to Example 1c the compound of the formula 106 is obtained from the compound of the formula 105 [prepared according to Example 3c] as a yellow resin. Mₙ: 2512; M_{w}: 3918; PDI: 1.56.

### EXAMPLE 4

### Preparation of the Compounds of the Formula 107 and 108

a) Preparation of the compound of the formula 107.

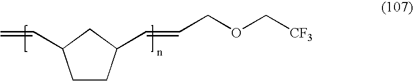

To a solution of 2.66 g (0.01 mol) of the compound of the formula A3 [prepared according to Example 3a] in 20 ml of toluene is added 0.19 g (0.26 mmol) of the catalyst bis(tricyclopentylphosphine)dichloro(3-methyl-2-butenylidene)ruthenium (APT Cat ASMC 716). A solution of 16.10 g (0.17 mol) of norbornene in 40 ml of toluene is dropped into the reaction mixture. The reaction mixture is kept at appr. 50° C. for 5 hours and then filtered. After evaporation of the solvent a dark resin is obtained. Mₙ: 2192; M_{w}: 3601; PDI: 1.64.
b) Preparation of the compound of the formula 108.

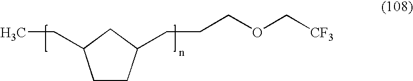

In analogy to Example 1c the compound of the formula 108 is obtained from the compound of the formula 107 [prepared according to Example 4a] as a white wax.

### EXAMPLE 5

### Preparation of the Compounds of the Formula 109 and 110

a) Preparation of the compound of the formula A5.

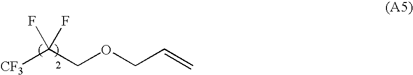

To a solution of 16.20 g (0.08 mol) of heptafluorobutanol in 50 ml of dibuthyl ether is added, during 2 hours 2.55 g (0.08 mol) of NaH. The suspension is kept in a sealed vessel for 1 hour at 50° C. then 8.4 ml (0.09 mol) of allyl bromide is added. The mixture is kept at 50° C. for 60 hours. Then 8 g of 4-(n-butylamino)-2,2,6,6-tetramethylpiperidine is added and the reaction mixture is stirred at 80° C. for 6 hours. The crude mixture is washed with water and then distilled at room pressure to give the compound of the formula A5 as a yellow oil (b.p. 137-140° C.). ¹H NMR: (300 MHz, CDCl₃): δ=5.90 (m, 1H, CH═), 5.27 (m, 2H, CH₂═), 4.00 (m, 2H, OCH₂), 3.90 (m, 2H, OCH₂).
b) Preparation of the compound of the formula A6.

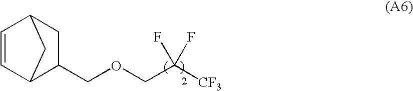

Into a sealed vessel is added 2.80 g (0.02 mol) of dicyclopentadiene and 21.00 g (0.04 mol) of the compound of the formula A5 [prepared according to Example 5a]. The mixture is kept at 165-170° C. for 72 hours. Then the reaction mixture is distilled at room pressure to give a colorless oil (b.p. 170-175° C.) of the compound of the formula A6. ¹H NMR: (300 MHz, CDCl₃), mixture of endo and exo isomers: δ=6.09 (m, 1H, CH═), 5.87 (m, 1H, CH═), 3.73 (m, 2H, OCH₂CF₂), 3.31 (m, 1H, OCHH), 3.18 (m, 1H, OCHH), 2.87 (m, 1H, CH), 2.75 (m, 1H, CH), 2.37 (m, 1H, CH), 1.75 (m, 1H, CHH), 1.52-1.12 (m, 2H, CH₂), 0.45 (m, 1H, CHH).
c) Preparation of the compound of the formula 109.

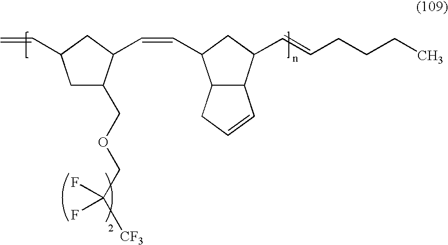

To a solution of 0.5 ml (4.20 mmol) of 1-hexene in 10 ml of toluene is added 0.30 g (0.56 mmol) of the catalyst bis(tricyclopentylphosphine)dichloro(3-methyl-2-butenylidene)ruthenium (APT Cat ASMC 716). A solution of 12.00 g (0.02 mol) of the compound of the formula A6 [prepared according to Example 5b] and 2.80 g (0.02 mol) of dicyclopentadiene in 15 ml of toluene is dropped into the reaction mixture. The reaction mixture is kept at appr. 50° C. for 6 hours and then filtered. After evaporation of the solvent the compound of the formula 109 is obtained as a brown resin.
d) Preparation of the compound of the formula 110.

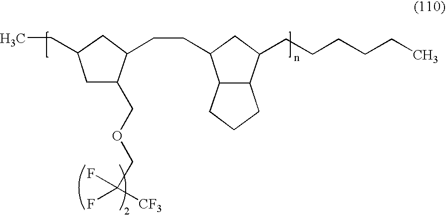

In analogy to Example 1c the compound of the formula 110 is obtained from the compound of the formula 109 [prepared according to Example 5c] as a white wax as a yellow resin. Mₙ: 2594; M_{w}: 4168; PDI: 1.61.

### EXAMPLE 6

### Preparation of the Compounds of the Formula 111 and 112

a) Preparation of the compound of the formula 111.

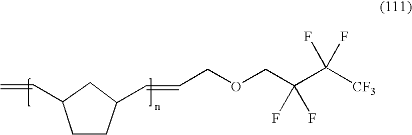

To a solution of 7.10 g (0.01 mol) of the compound of the formula A5 [prepared according to Example 5a] in 20 ml of toluene is added 0.20 g (0.28 mmol) of the catalyst bis(tricyclopentylphosphine)dichloro(3-methyl-2-butenylidene)ruthenium (APT Cat ASMC 716). A solution of 16.10 g (0.17 mol) of norbornene in 40 ml of toluene is dropped into the reaction mixture. The reaction mixture is kept at appr. 50° C. for 6 hours and then filtered. Evaporation of the solvent gives the compound of the formula 111 as a dark resin. Mₙ: 2475; M_{w}: 3136; PDI: 1.27.
b) Preparation of the compound of the formula 112.

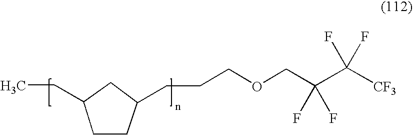

In analogy to Example 1c the compound of the formula 112 is obtained from the compound of the formula 111 [prepared according to Example 6a] as a white wax.

### EXAMPLE 7

### Preparation of the Compounds of the Formula 113 and 114

a) Preparation of the compound of the formula A7.

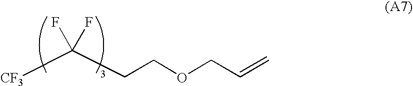

To a solution of 20.20 g (0.08 mol) of 1H,1H,2H,2H-nonafluoro-1-hexanol, dissolved in 55 ml of THF is added 6.12 g (0.16 mol) of NaOH and 0.54 g of Bu₄NBr. Into the reaction mixture is dropped 16.2 ml (0.20 mol) of allyl bromide. The reaction mixture is refluxed for 5 hours. After cooling to room temperature, the reaction mixture is filtered and the solvent distilled at room pressure to give the compound of the formula A7 as a yellow oil. ¹H NMR: (300 MHz, CDCl₃): δ=5.90 (m, 1H, CH═), 5.27 (dd, 2H, CH₂═), 4.00 (m, 2H, OCH₂), 3.71 (t, 2H, OCH₂), 2.41 (m, 2H, CH₂CF₂).
b) Preparation of the compound of the formula A8.

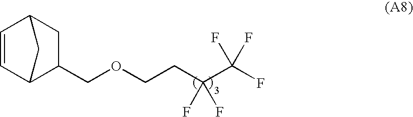

Into a sealed vessel is added 3.93 g (0.03 mol) of dicyclopentadiene and 15.10 g (0.05 mol) of the compound of the formula A7 [prepared according to Example 7a]. The reaction mixture is kept at 165-170° C. for 20 hours. Then the reaction mixture is distilled at 4 mmHg to give the compound of the formula A8 as a colorless oil (b.p. 80-82° C.). ¹H NMR: (300 MHz, CDCl₃), mixture of endo and exo isomers: δ=6.10 (m, 1H, CH═), 5.90 (m, 1H, CH═), 3.68 (m, 2H, OCH₂), 3.19 (t, 1H, CHH), 3.07 (t, 1H, CHH), 2.87 (m, 1H, CH), 2.75 (m, 1H, CH), 2.36 (m, 3H, CH and CH₂CF₂), 1.83 (m, 1H, CHH), 1.45 (m, 1H, CHH), 1.25 (m, 1H, CHH), 0.50 (m, 1H, CHH).
c) Preparation of the compound of the formula 113.

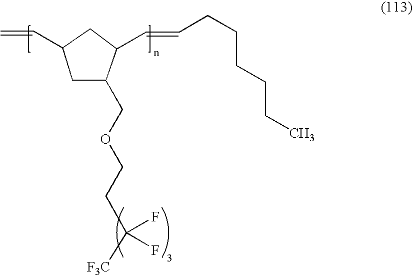

To a solution of 0.2 ml (1.13 mmol) of 1-octene in 5 ml of toluene is added 0.14 g (0.19 mmol) of the catalyst bis(tricyclopentylphosphine)dichloro(3-methyl-2-butenylidene)ruthenium (APT Cat ASMC 716). A solution of 5.00 g (0.01 mol) of the compound of the formula A8 [prepared according to Example 7b] in 10 ml of toluene is dropped into the reaction mixture. The reaction mixture is kept at appr. 50° C. for 6 hours and then filtered. Evaporation of the solvent gives the compound of the formula 113 as a yellow resin. Mₙ: 3351; M_{w}: 6915; PDI: 2.06.
d) Preparation of the compound of the formula 114.

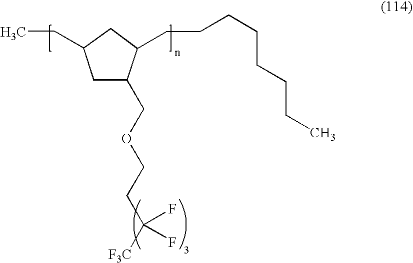

In analogy to Example 1c the compound of the formula 114 is obtained from the compound of the formula 113 [prepared according to Example 7c] as a yellow resin.

### EXAMPLE 8

### Preparation of the Compounds of the Formula 115 and 116

a) Preparation of the compound of the formula A9.

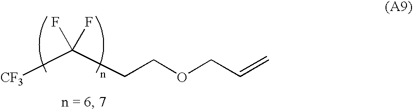

To a solution of 39.26 g (0.09 mol) of Zonyl-BA-L® in 60 ml of THF is added 7.09 g (0.18 mol) of NaOH and 0.63 g of Bu₄NBr. Into the reaction mixture is dropped 18.7 ml (0.22 mol) of allyl bromide. The reaction mixture is refluxed for 5 hours and then filtered. Evaporation of the solvent gives the compound of the formula A9 as a yellow oil. ¹H NMR: (300 MHz, CDCl₃): δ=5.90 (m, 1H, CH═), 5.27 (dd, 2H, CH2═), 4.02 (m, 2H, OCH₂), 3.73 (m, 2H, OCH₂), 2.43 (m, 2H, CH₂CF₂).
b) Preparation of the compound of the formula A10.

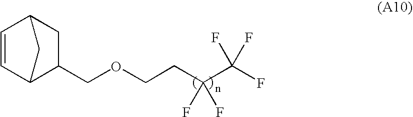

Into a sealed vessel is added 4.03 g (0.03 mol) of dicyclopentadiene and 24.63 g (0.05 mol) of the compound of the formula A9 [prepared according to Example 8a]. The reaction mixture is kept at 165-170° C. for 20 hours. Distillation of the reaction mixture at 1.5 mmHg gives the compound of the formula A10 as a colorless oil (boiling range 70-126° C.). ¹H NMR: (300 MHz, CDCl₃), mixture of endo and exo isomers: δ=6.12 (m, 1H, CH═), 5.93 (m, 1H, CH═), 3.70 (m, 2H, OCH₂), 3.20 (m, 1H, CHH), 3.08 (t, 1H, CHH), 2.92 (m, 1H, CH), 2.81 (m, 1H, CH), 2.37 (m, 3H, CH and CH₂CF₂), 1.83 (m, 1H, CHH), 1.45 (m, 1H, CHH), 1.26 (m, 1H, CHH), 0.50 (m, 1H, CHH).
c) Preparation of the compound of the formula 115.

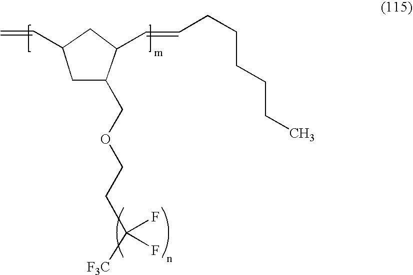

To a solution of 1.2 ml (7.59 mmol) of 1-octene in 33 ml of toluene is added 1.33 g (1.86 mmol) of the catalyst bis(tricydopentylphosphine)dichloro(3-methyl-2-butenylidene)ruthenium (APT Cat ASMC 716). A solution of 50.00 g (0.09 mol) of the compound of the formula A10 [prepared according to Example 8b] in 65 ml of toluene is dropped into the reaction mixture. The reaction mixture is kept at appr. 50° C. for 6 hours and then filtered. Evaporation of the solvent gives the compound of the formula 115 as a yellow resin. Mₙ: 3517; M_{w}: 4980; PDI: 1.42.
d) Preparation of the compound of the formula 116.

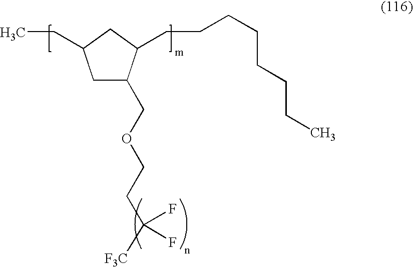

In analogy to Example 1c the compound of the formula 116 is obtained from the compound of the formula 115 [prepared according to Example 8c] as a yellow resin. Mₙ: 3139; M_{w}: 5008; PDI: 1.60.

### EXAMPLE 9

### Preparation of the Compounds of the Formula 117 and 118

a) Preparation of the compound of the formula A11.

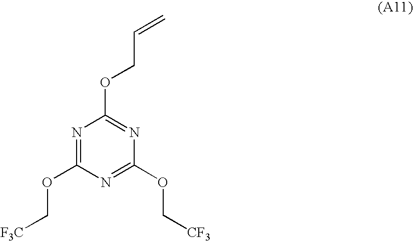

To a solution of 30.00 g (0.15 mol) of allyloxy-dichloro-[1,3,5]-triazine in 200 ml toluene is added 40.00 g (0.40 mol) of trifluoroethanol and 60.50 g (0.44 mol) of K₂CO₃. The reaction mixture is kept at 70° C. for 5 hours and then washed with water. Evaporation of the solvent and distillation under vacuum (b.p. 90° C.) gives the compound of the formula A11 as a colorless oil. ¹H NMR: (300 MHz, CDCl₃): δ=6.00 (m, 1H, CH═), 5.34 (m, 2H, CH₂═), 4.93 (m, 2H, OCH₂ and 2OCH₂CF₃).
b) Preparation of the compound of the formula 117.

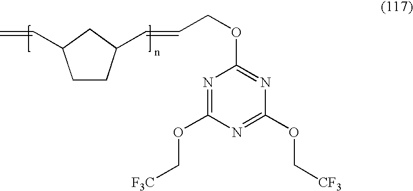

To a solution of 4.00 g (0.01 mol) of the compound of the formula A11 [prepared according to Example 9a] in 30 ml of toluene is added 0.16 g (0.22 mmol) of the catalyst bis(tricyclopentylphosphine) dichloro(3-methyl-2-butenylidene)ruthenium (APT Cat ASMC 716). A solution of 13.60 g (0.14 mol) of norbornene in 30 ml of toluene is dropped into the reaction mixture. The reaction mixture is kept at appr. 50° C. for 4 hours and then filtered. Evaporation of the solvent gives the compound of the formula 117 as a brown resin. Mₙ: 3386; M_{w}: 6165; PDI: 1.80.
c) Preparation of the compound of the formula 118.

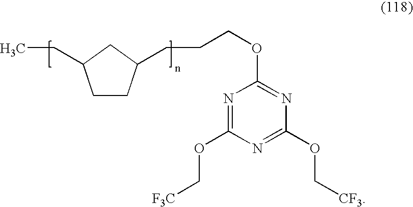

In analogy to Example 1c the compound of the formula 118 is obtained from the compound of the formula 117 [prepared according to Example 9b] as a yellow resin.

### EXAMPLE 10

### Preparation of the Compounds of the Formula 119 and 120

a) Preparation of the compound of the formula A12.

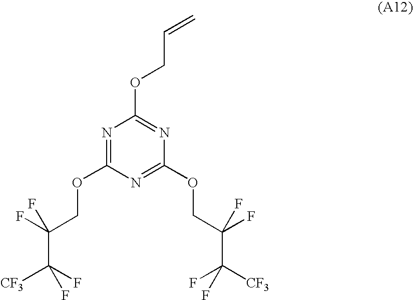

In a sealed vessel is added 10.00 g (0.05 mol) of allyloxy-dichloro-[1,3,5]-triazine, 22.30 g (0.11 mol) of 1H,1H-eptafluoro-1-butanol, 100 ml of toluene and 26.00 g (0.19 mol) of K₂CO₃. The reaction mixture is kept at 80° C. for 30 hours. The reaction mixture is filtered and chromatographed at silica gel to give the compound of the formula A12 as a colorless wax. 1H NMR: (300 MHz, CDCl₃): δ=6.00 (m, 1H, CH═), 5.34 (m, 2H, CH₂═), 4.93 (m, 6H, OCH₂ and 2OCH₂CF₂).
b) Preparation of the compound of the formula 119.

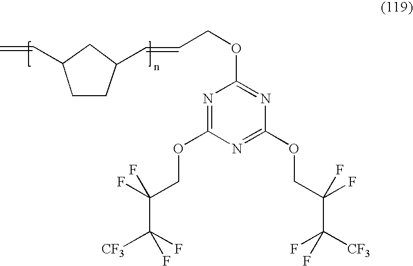

To a solution of 5.20 g (0.01 mol) of the compound of the formula A12 [prepared according to Example 10a] in 30 ml of toluene is added 0.13 g (0.18 mmol) of the catalyst bis(tricyclopentylphosphine) dichloro(3-methyl-2-butenylidene)ruthenium (APT Cat ASMC 716). A solution of 11.00 g (0.12 mol) of norbornene in 30 ml of toluene is dropped into the reaction mixture. The reaction mixture is kept at appr. 50° C. for 6 hours and then filtered. Evaporation of the solvent gives the compound of the formula 119 as a brown resin. Mₙ: 3356; M_{w}: 4847; PDI: 1.44.
c) Preparation of the compound of the formula 120.

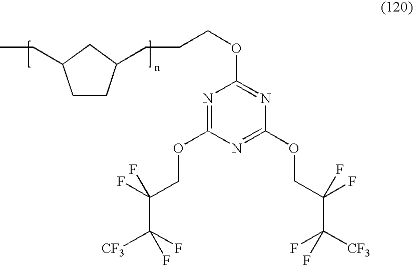

In analogy to Example 1c the compound of the formula 120 is obtained from the compound of the formula 119 [prepared according to Example 10b] as a white resin.

### EXAMPLE 11

### Preparation of the Compounds of the Formula 121 and 122

a) Preparation of the compound of the formula A13.

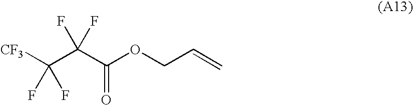

To a solution of 3.80 g (0.06 mol) of allyl alcohol in 70 ml of di-butyl ether is added 15.4 ml of tributyl amine and then dropwise 10.00 g (0.04 mol) of heptafluorobutyric chloride at room temperature during 30 minutes. The reaction mixture is stirred at room temperature for 5 hours. The reaction mixture was washed with water. Distillation of the organic phase at room pressure gives the compound of the formula A13 as a colourless oil. ¹H NMR: (300 MHz, CDCl₃): δ=6.20 (m, 1H, CH═), 5.50 (m, 2H, CH₂═), 5.00 (m, 2H, OCH₂).
b) Preparation of the compound of the formula 121.

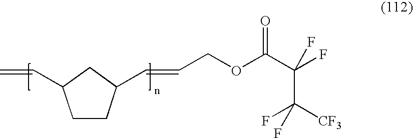

To a solution of 17.70 g (0.01 mol) of the compound of the formula A13 [prepared according to Example 11a] in 20 ml of toluene is added 0.18 g (0.25 mmol) of the catalyst bis(tricyclopentylphosphine) dichloro(3-methyl-2-butenylidene)ruthenium (APT Cat ASMC 716). A solution of 15.00 g (0.16 mol) of norbornene in 30 ml of toluene is dropped into the reaction mixture. The reaction mixture is kept at appr. 50° C. for 6 hours and then filtered. Evaporation of the solvent gives the compound of the formula 121 as a dark resin. Mₙ: 3736; M_{w}: 6247; PDI: 1.67
c) Preparation of the compound of the formula 122.

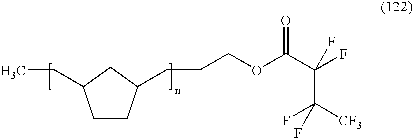

In analogy to Example 1c the compound of the formula 122 is obtained from the compound of the formula 121 [prepared according to Example 11 b] as a yellow resin.

### EXAMPLE 12

### Preparation of the Compounds of the Formula 123 and 124

a) Preparation of the compound of the formula 123.

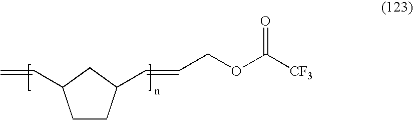

To a solution of 1.36 g (8.85 mmol) of allyl trifluoroacetate in 15 ml of toluene is added 0.12 g (0.17 mmol) of the catalyst bis(tricyclopentylphosphine)dichloro(3-methyl-2-butenylidene) -ruthenium (APT Cat ASMC 716). A solution of 10.00 g (0.11 mol) of norbornene in 25 ml of toluene is dropped into the reaction mixture. The reaction mixture is kept at appr. 50° C. for 6 hours and then filtered. Evaporation of the solvent gives the compound of the formula 123 as a dark resin. Mₙ: 3014; M_{w}: 5535; PDI: 1.84
b) Preparation of the compound of the formula 124.

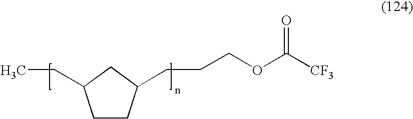

In analogy to Example 1c the compound of the formula 124 is obtained from the compound of the formula 123 [prepared according to Example 12a] as a yellow resin.

### EXAMPLE 13

### Preparation of the Compounds of the Formula 125 and 126

a) Preparation of the compound of the formula 125.

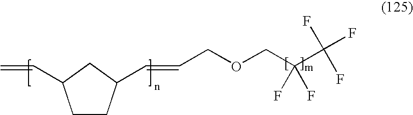

To a solution of 11.20 g (0.16 mol) of the compound of the formula A9 [prepared according to Example 8a] in 75 ml of dichloromethane is added 0.11 g (0.15 mmol) of the catalyst bis -(tricyclopentylphosphine)dichloro(3-methyl-2-butenylidene)ruthenium (APT Cat ASMC 716). A solution of 15.00 g (0.16 mol) of norbornene in 25 ml of dichloromethane is dropped into the reaction mixture. The reaction mixture is kept at appr. 40° C. for 8 hours and then filtered. Evaporation of the solvent gives the compound of the formula 125 as a dark resin. Mₙ: 2413; M_{w}: 2879; PDI: 1.19.
b) Preparation of the compound of the formula 126.

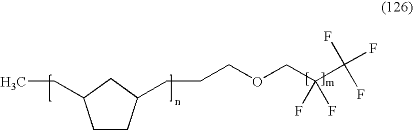

In analogy to Example 1c the compound of the formula 126 is obtained from the compound of the formula 125 [prepared according to Example 13a] as a white wax. Mₙ: 2219; M_{w}: 2528; PDI: 1.14.

### EXAMPLE 14

### Preparation of the Compounds of the Formula 127

a) Preparation of the compound of the formula A14.

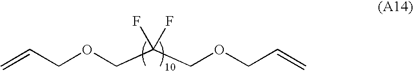

Into a solution of 4.50 g (8.00 mmol) of 1H,1H,12H,12H-perfluoro-1,12-dodecanediol in 150 ml of MIBK is added 1.28 g (32.02 mmol) of sodium hydroxide and 3.4 ml (40.03 mmol) of allyl bromide. The mixture is kept at 60° C. for one night then filtered. The solution is washed with water and after evaporation of the solvent 4.32 g of the compound of the formula A14 is obtained as a yellow oil. ¹H-NMR (300 MHz, CDCl₃): δ=5.85 (m, 1H, CH═); 5.25 (t, 2H, CH₂═, J=15Hz); 4.10 (d, 2H, CH₂, J=7.5Hz); 3.90 (t, 2H, CH₂, J=15Hz).
b) Preparation of the compound of the formula 127.

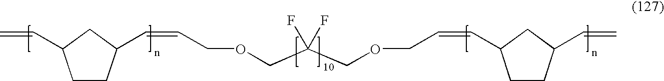

To a solution of 4.20 g (6.54 mmol) of the compound of the formula A14 [prepared according to Example 14a] in 30 ml of dichloromethane is added 0.36 g (0.51 mmol) of the catalyst bis(tricyclopentylphosphine)dichloro(3-methyl-2-butenylidene)ruthenium (APT Cat ASMC 716). The mixture is heated to reflux. Then a solution of 4.92 (52.32 mmol) of norbornene in 25 ml of dichloromethane is dropped into the reaction mixture. The mixture is kept at reflux for 3 hours then filtered. After evaporation of the solvent 8.29 g of the compound of the formula 127 is obtained as a brown spongy solid. Mₙ: 2933; M_{w}: 4838; PDI: 1.65.

### EXAMPLE 15

### Preparation of the Compounds of the Formula A15

a) Preparation of the compound of the formula A15.

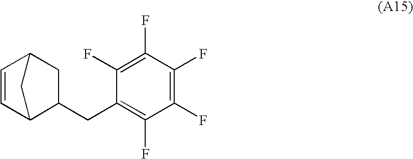

Into a sealed vessel is introduced 11.0 g (52.85 mmol) of allylpentafluorobenzene and 4.18 g (31.71 mmol) of dicyclopentadiene. The mixture is kept at 165-170° C. for 48 hours. The crude mixture is then distilled under vacuum at 67-69° C. (0.8 mm Hg), obtaining 7.20 g of the compound of the formula A15 as colorless oil. ¹H-NMR (300 MHz, CDCl₃): δ=6.16 (m, 1H, CH═), 5.95 (m, 1H, CH═), 2.70 (m, 1H, CH), 2.54 (m, 1H, CH), 2.36 (m, 2H, CH₂Ar), 1.77 (m, 1H, CHH), 1.34 (m, 1H, CHH), 1.13 (m, 1H, CHH), 0.55 (m, 1H, CHH).
b) Preparation of the compound of the formula 128.

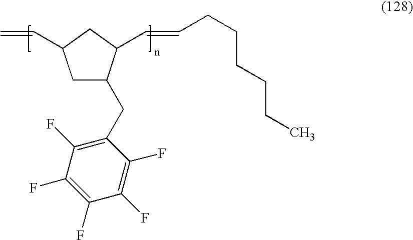

To a solution of 5.31 g (19.36 mmol) of the compound of the formula A15 [prepared according to Example 15a] in 20 ml of toluene is added 0.25 ml (1.61 mmol) of 1-octene and 0.13 g (0.18 mmol) of the catalyst bis(tricyclopentylphosphine)dichloro(3-methyl-2-butenylidene) ruthenium (APT Cat ASMC 716). The mixture is heated at 85° C. and kept at this temperature for 18 hours. After filtration and evaporation of the solvent 4.93 g of the compound of the formula 128 is obtained as a yellow solid (p.f.: 72-79° C.). Mn: 4052; Mw: 8367; PDI: 2.06.

### EXAMPLE 16

### Water and Oil Repellency in Polypropylene

In order to determine the repellency properties of the compounds of the formula I, they are tested according to the following procedure. The sample preparation is a combination of polypropylene nonwovens and the additive and a thermal treatment (e.g. 130° C. for 10 minutes), which enables the migration of the additive to the surface and a proper surface rearrangement of the chemical groups. This extra heat cycle is needed to melt the compounds of the formula I in order to obtain a homogeneous redistribution over the surface of the substrate. An industrial sample of polypropylene nonwoven, fabric weight: 40 g/m², was dipped into a 1% isopropanol solution of the test compound, simultaneously applying ultrasonic energy for one minute. After that, the sample is dried overnight at room temperature and then two hours at 90° C. in an oven. A part of the sample is afterwards annealed for 10 minutes at 130° C.

The treated nonwoven samples were evaluated in the water repellency test similar to INDA test method 80.8 (99). The wetting behavior of the nonwovens was tested with a series of water/isopropanol mixtures. The observation of the wetting behavior is rated from 0 (water wetting, no repellency) to 10 (optimum water repellency). The results are summarized in Table 1.

TABLE 1

| | | Water repellency | Water repellency |
|---|---|---|---|
| Example | Compound | after drying | after annealing |
| 14a^{a)} | — | 2 | 2 |
| 14b^{b)} | 104 | 4 | 6 |
| 14c^{b)} | 106 | 2 | 3 |
| 14d^{b)} | 110 | 3 | 3 |
| 14e^{b)} | 113 | 7 | 6 |
| 14f^{b)} | 114 | 4 | 5 |
| 14g^{b)} | 116 | 7 | 9 |
| 14h^{b)} | 120 | 5 | 4 |

^{a)}Comparative Example.
^{b)}Example according to the invention.

The treated nonwoven samples are evaluated in the oil repellency test similar to AATCC test method 118-1997/ISO 14419. This test follows the same concepts of the already described for water repellency test method, but using, as test solvents, a series of hydrocarbons. The observation of the wetting behavior is rated from 0 (no repellency) to 8 (optimum repellency). The results are summarized in Table 2.

TABLE 2

| | | Oil repellency | Oil repellency |
|---|---|---|---|
| Example | Compound | after drying | after annealing |
| 14i^{a)} | — | 0 | 0 |
| 14k^{b)} | 104 | 0 | 1 |
| 14l^{b)} | 113 | 4 | 5 |
| 14m^{b)} | 116 | 2 | 2 |
| 14n^{b)} | 120 | 2 | 1 |

^{a)}Comparative Example.
^{b)}Example according to the invention.

1. A compound of the formula I 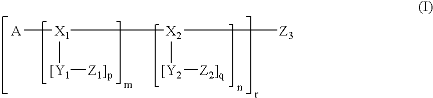
wherein
m and n independently of one another are zero, one or a numeral greater than one, with the proviso that the sum of m and n is at least two;
p and q independently of one another are zero, one or a numeral greater than one, with the proviso that, when p and q are zero, Z₃ is a fluorine containing group;
r is 1, 2, 3 or 4,
A and Z₃ represent chain terminal groups from the chain transfer agent (A)ᵣ—Z₃;
X₁ and X₂ independently of one another represent unsaturated or hydrogenated repeating units from cycloolefins polymerized by metathesis;
Y₁ and Y₂ independently of one another represent identical or different bivalent groups;
Z₁ and Z₂ independently of one another represent a fluorine containing residue, and
Z₃ represents a mono-, di-, tri- or tetra-valent residue or a mono-, di-, tri- or tetra-valent residue optionally substituted with a fluorine containing residue.

2. A compound according to claim 1, wherein one of m and n represents a numeral from 2 to 50; and the other one represents zero.

3. A compound according to claim 1, wherein p and q independently of one another are 0 or 1, with the proviso that, when p and q are 0, Z₃ is a fluorine containing group.

4. A compound according to claim 1, wherein X₁ and X₂ independently of one another represent unsaturated or hydrogenated repeating units from cycloolefins polymerized by metathesis selected from the group consisting of cyclopropene, cyclobutene, cyclopentene, cyclohexene, cycloheptene, cyclooctene, cyclopentadiene, dicyclopentadiene, cyclohexadiene, cycloheptadiene, cyclooctadiene, norbornadiene, norbornene and norbornene derivatives.

5. A compound according to claim 1, wherein in the chain transfer agent (A)ᵣ—Z₃,
wherein, when r is 1,
A—Z₃ is C₃-C₂₅alkyl-1-ene, trifluoroethyl allyl ether, heptafluorobutyl allyl ether, nonafluorohexyl allyl ether, CF₃(CF₂)₆CH₂CH₂OCH₂CH═CH₂, CF₃(CF₂)₇CH₂CH₂OCH₂CH═CH₂, allyl trifluoroacetate, 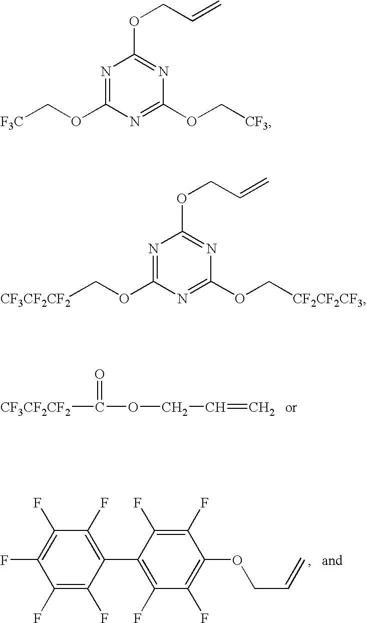
wherein, when r is 2,
(A)₂—Z₃ is H₂C═CH—CH₂—O [symbol] CF₂ [symbol] ₉CH₂—CH₂—O—CH₂—CH═CH₂ or
H₂C═CH—CH₂—O—CH₂ [symbol] CF₂ [symbol] ₁₀CH₂—O—CH₂—CH═CH₂.

6. A compound according to claim 1, wherein
Z₁ and Z₂ independently of one another represent a fluorine containing residue selected from the group consisting of C₃-C₂₅fluoroalkyl, C₃-C₂₅fluoroalkoxy and

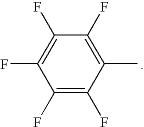

7. A compound according to claim 1, wherein Y₁ and Y₂ independently of one another is a direct bond or methylene.

8. A compound according to claim 1, wherein
one of m and n represents a numeral from 2 to 20; and the other one represents zero,
p and q independently of one another are 0 or 1, with the proviso that, when p and q are 0, Z₃ is a fluorine containing group;
r is 1 or 2,
A and Z₃ represent chain terminal groups from the chain transfer agent (A)ᵣ—Z₃;
X₁ and X₂ independently of one another represent unsaturated or hydrogenated repeating units from cycloolefins polymerized by metathesis selected from the group consisting of cyclopentadiene, dicyclopentadiene, norbornadiene, norbornene and norbornene derivatives,
Y₁ and Y₂ independently of one another is a direct bond or methylene,
Z₁ and Z₂ independently of one another represent a fluorine containing residue selected from the group consisting of C₃-C₂₅fluoroalkyl, C₃-C₂₅fluoroalkoxy or 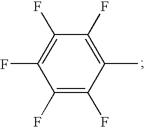
and
when r is 1,
A—Z₃ is C₃-C₂₅alkyl-1-ene, trifluoroethyl allyl ether, heptafluorobutyl allyl ether, nonafluorohexyl allyl ether, CF₃(CF₂)₆CH₂CH₂OCH₂CH═CH₂, CF₃(CF₂)₇CH₂CH₂OCH₂CH═CH₂, allyl trifluoroacetate, 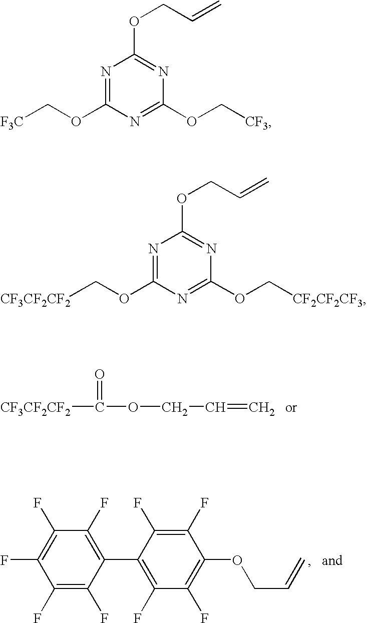
when r is 2,
(A)₂—Z₃ is H₂C═CH—CH₂—O [symbol] CF₂ [symbol] ₉CH₂—CH₂—O—CH₂—CH═CH₂ or
H₂C═CH—CH₂—O—CH₂ [symbol] CF₂ [symbol] ₁₀CH₂—O—CH₂—CH═CH₂.

9. A polymerisable composition comprising
a) a catalytically effective amount of a penta- or hexavalent ruthenium or osmium carbene catalyst capable of performing ring opening metathesis polymerization of cycloolefins; and
b) the chain transfer agent (A)ᵣ—Z₃ according to claim 1 and monomers capable of forming a compound of the formula I according to claim 1.

10. A polymerisable composition according to claim 9 comprising as component (a) a catalytically effective amount of a penta- or hexavalent ruthenium or osmium carbene catalyst of the formulae IIa or IIb 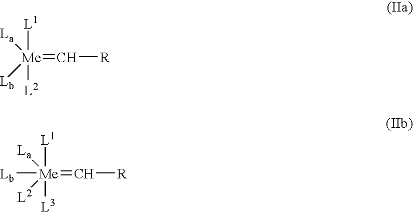
wherein
Me represents ruthenium or osmium;
Lₐ and L_{b} independently of one another represent anionic ligands;
L¹, L² and L³ independently of one another represent monodentate, neutral e⁻ donor ligands; and
R represents aryl, arylthio or C₃-C₅alkenyl.

11. A polymerisable composition according to claim 9 comprising as component (a) a catalytically effective amount of a penta- or hexavalent ruthenium carbene catalyst

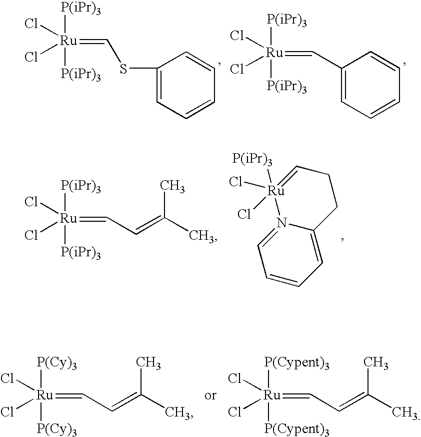

12. A composition comprising
a) an organic material which is susceptible to oxidative, thermal or light-induced degradation, and
b) at least one compound of the formula I according to claim 1.

13. A composition according to claim 12 wherein component (a) is a natural, semi-synthetic or synthetic polymer.

14. A composition according to claim 12 wherein component (a) is a synthetic polymer.

15. A composition according to claim 12 wherein component (b) is present in an amount of from 0.001 to 10%, based on the weight of component (a).

16. A composition according to claim 12, comprising in addition to components (a) and (b), further additives.

17. A composition according to claim 16, comprising as further additives phenolic antioxidants, light-stabilizers and/or processing stabilizers.

18. A process for increasing the oil and water repellency of organic materials which comprises incorporating therein or applying thereto at least one compound of the formula I according to claim 1.

19. (canceled)
